(19) United States
(12) Patent Application Publication
(10) Pub. No.: US 2007/0174197 A1
(43) Pub. Date: Jul. 26, 2007

(54) Method to protect digital data using the open mobile alliance digital rights management standard

(75) Inventor: Chi-Bin Li, Sindian City (TW)

Correspondence Address: BACON & THOMAS, PLLC, 625 SLATERS LANE, FOURTH FLOOR, ALEXANDRIA, VA, 22314, US

(73) Assignee: Mobile Action Technology Inc., Sindian City (TW)

(21) Appl. No.: 11/326,318

(22) Filed: Jan. 6, 2006

(51) Int. Cl. G06Q 99/00

(52) U.S. Cl. 705/51

(57) ABSTRACT

A method to protect digital rights using an OMA DRM standard has acts of generating an encryption key and an ID unique to a user and a decryption key, encrypting the digital content using the encryption key into an encrypted object, packaging the ID and the decryption key into a rights object, delivering the ID and the encrypted object to the user's mobile device, delivering the rights object to the user's mobile device, verifying ID delivered with the encrypted object and ID in the rights object and decrypting the encrypted object. The method replaces assigning a conventional identifier to each digitized content with assigning each user a unique ID. For either the rental service or the purchase service all downloaded content in the user's mobile device is accessible based on the same rights object to improve unreasonably receiving so many rights objects for each downloaded digital content.

### BACKGROUND OF THE INVENTION

1. Field of the Invention

The present invention relates to a method, and more particularly to a method to protect digital rights using Open Mobile Alliance (OMA) digital rights management (DRM) standard.

2. Description of Related Art

The advancement of computer and multimedia technology has resulted in most multimedia content such as audio, video, text, etc. being digitized because digitized data can be stored, transmitted and presented with virtually no distortion or signal losses. Digital content is easier to copy, store and disseminate, but it is also easier to pirate. Therefore, the protection of digital rights is more important in the current communication environment.

Digital rights management (DRM) is a standard to protect copyrighted content implemented with digital data. Typically in the art about mobile devices, a DRM standard presented by Open Mobile Alliance (OMA) includes the ability to preview digital content and to prevent downloaded content from being used by other users. An OMA DRM system protects an article by encrypting a digital file of the article and assigning the digital file a unique identifier so the encrypted digitized article can only be accessed by authorized users to keep the article from being freely distributed. Authorized users receive a rights object containing a decryption key, the unique identifier, and associated authorization information to decrypt the encrypted object.

The OMA DRM standard suggests that each digitized content used in an OMA DRM system have its own unique identifier. In other words, the more digital content a user has, the more rights objects the user may receive. Especially in a periodic rental service, the provider delivers not only rights objects for ever-downloaded digital content once in a period, but also rights objects for new-downloaded digital content. However, mobile devices have limited memory, receiving so many rights objects for each content is unreasonable. The cost of sending so many rights objects also reduces the provider's profit more and more as time goes on.

To overcome the shortcomings, the present invention provides a method to protect digital rights for mobile devices with an OMA DRM specification to mitigate or obviate the aforementioned problems.

### SUMMARY OF THE INVENTION

The main objective of the invention is to provide a method to protect digital rights using DRM standard.

To achieve the objective, a method in accordance with the present invention comprises acts of (1) generating an encryption key and an ID unique to a user and a decryption key, (2) encrypting a digital content using the encryption key into an encrypted object, (3) packaging the ID and the decryption key into a rights object, (4) delivering the ID and the encrypted object to the user's mobile device, (5) delivering the rights object to the user's mobile device, (6) verifying ID delivered with the encrypted object and ID in the rights object and (7) decrypting the encrypted object.

Other objectives, advantages and novel features of the invention will become more apparent from the following detailed description when taken in conjunction with the accompanying drawings.

### BRIEF DESCRIPTION OF THE DRAWING

FIG. 1 is a flow chart of the method to protect digital rights using the OMA DRM standard in accordance with the present invention.

### DETAILED DESCRIPTION OF PREFERRED EMBODIMENT

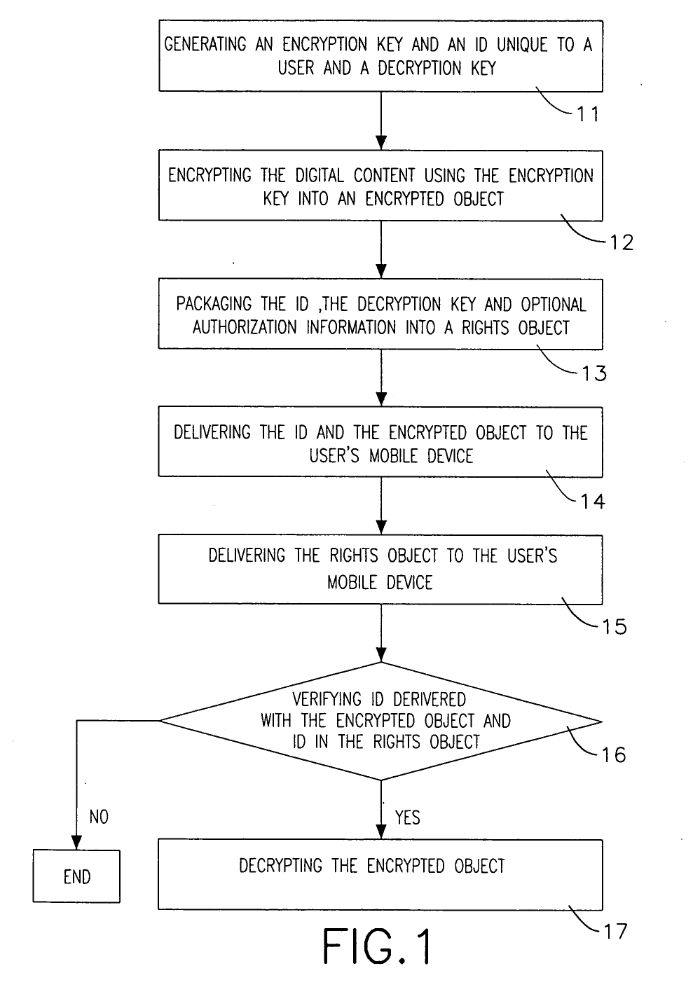

With reference to FIG. 1, a method to protect digital rights using DRM standard in accordance with the present invention may be use in a periodic digital content rental service, such as a monthly rental service, or in a purchase service and comprises acts of (1) generating an encryption key and an ID unique to a user, and a decryption key, (2) encrypting a digital content using the encryption key into an encrypted object, (3) packaging the ID, the decryption key and optional authorization information into a rights object, (4) delivering the ID and the encrypted object to the user's mobile device, (5) delivering the rights object to the user's mobile device, (6) verifying ID delivered with the encrypted object and ID in the rights object and (7) decrypting the encrypted object.

The act of generating an encryption key and an ID unique to a user and a decryption key (11) comprises generating an encryption key and an ID both being unique to a user and a decryption key corresponding to the encryption key. The encryption key, the ID and the decryption key are assigned by the content provider.

The act of encrypting a digital content using the encryption key into an encrypted object (12) comprises encrypting a digital content required by the user into an encrypted object with the encryption key by the content provider. The digital content required by the user may be digital audio, digital video, digital text or the like, and the encrypted object is made available publicly by the content provider, such as publishing the encrypted object on a Web page.

The act of packaging the ID, the decryption key and optional authorization information into a rights object (13) comprises packaging the ID, the decryption key and optional authorization information into a rights object corresponding to the encrypted object by the content provider. The authorization information may comprise an expiration date for availability of the digital content when the method is use in a periodic digital content rental service.

The act of delivering the ID and the encrypted object to the user's mobile device (14) comprises sending the ID and the encrypted object from the content provider to the user's mobile device through a deliverer. The user's mobile device may be a digital notebook, a cell phone, a Personal Digital Assistant (PDA) or the like, and the deliverer may be Hypertext Transfer Protocol (HTTP), Wireless Application Protocol (WAP) or Multimedia Messaging Service (MMS).

The act of delivering the rights object to the user's mobile device (15) comprises the content provider sending the rights object to the user's mobile device through the deliverer.

The act of verifying ID delivered with the encrypted object and ID in the rights object (17) comprises verifying if the ID delivered with the encrypted object and in the rights object is equivalent. If yes, doing the act of decrypting the encrypted object (17) by using the decryption key in the received rights object.

The method in accordance with the present invention replaces assigning a conventional identifier to each digital content with an ID unique to a user. For either the rental service or the purchase service, all downloaded content in the user's mobile device is accessible based on the same rights object. The difference between the periodic rental service and the purchase service is that user's mobile device receives rights object once per a certain period in the periodic rental service. Therefore, the user's mobile device will not receive so many rights objects conventional-like when the content provider supplies a periodic rental service.

With such a method, all digital content required by a user has the same encryption key, ID and decryption key and the encryption key and the ID are unique to a user. Therefore, the user's mobile device receives much less rights objects than conventional DRM methods.

Even though numerous characteristics and advantages of the present invention have been set forth in the foregoing description, together with details of the structure and function of the invention, the disclosure is illustrative only. Changes may be made in detail especially in matters of arrangement of parts within the principles of the invention to the full extent indicated by the broad general meaning of the terms in which the appended claims are expressed.

What is claimed is:

1. A method to protect digital data using the OMA DRM standard comprising acts of:
generating
an encryption key and an ID unique to a user assigned by a content provider;
a decryption key corresponding to the encryption key and;
encrypting a digital content into an encrypted object with the encryption key and making the encrypted object available publicly by the content provider;
packaging the ID and the decryption key into a rights object corresponding to the encrypted object by the content provider;
delivering the ID and the encrypted object to the user's mobile device through a deliverer;
delivering the rights object to the user's mobile device through the deliverer;
verifying ID delivered with the encrypted object and ID in the rights object; and
decrypting the encrypted object.

2. The method as claimed in claim 1 being used to provide a periodic digital content rental service.

3. The method as claimed in claim 1 being used to provide a digital content purchase service.

4. The method as claimed in claim 1, wherein the content provider publishes the encrypted object on a Web page.

5. The method as claimed in claim 1, wherein the rights object further comprises authorization information.

6. The method as claimed in claim 2, wherein the rights object further comprises authorization information.

7. The method as claimed in claim 6, wherein the authorization information comprises a digital content expiration date when the method is use in a periodic digital content rental service.

8. The method as claimed in claim 1, wherein the user's mobile device is a cell phone.

9. The method as claimed in claim 1, wherein the deliverer is Hypertext Transfer Protocol (HTTP).

10. The method as claimed in claim 1, wherein all downloaded content in the user's mobile device is accessible based on the same rights object.

11. The method as claimed in claim 2, wherein all downloaded content in the user's mobile device is accessible based on the same rights object.
